(19) United States
(12) Patent Application Publication
(10) Pub. No.: US 2020/0308040 A1
(43) Pub. Date: Oct. 1, 2020

(54) MULTI-ELEVATION DRIVE APPARATUS FOR A GLASS MANUFACTURING APPARATUS WITH TENSION CONTROL IN BOTTOM OF DRAW

(71) Applicant: Corning Incorporated, Corning, NY (US)

(72) Inventors: Tomohiro Aburada, Painted Post, NY (US); Gautam Narendra Kudva, Horseheads, NY (US); Shawn Rachelle Markham, Harrodsburg, KY (US)

(21) Appl. No.: 16/311,002

(22) PCT Filed: Jun. 20, 2017
(86) PCT No.: PCT/US2017/038242

§ 371 Date: Dec. 18, 2018

Related U.S. Application Data
(60) Provisional application No. 62/352,770, filed on Jun. 21, 2016.

(51) Int. Cl. C03B 17/06; C03B 33/02

(52) U.S. Cl. CPC C03B 17/068; C03B 17/064; C03B 33/0215

(57) ABSTRACT

A glass manufacturing apparatus includes a forming device that is configured to produce a glass ribbon that includes a width extending between a first edge and an opposite second edge of the glass ribbon. A lower draw roll apparatus includes a first pair of draw rolls arranged and configured to draw the first edge of the glass ribbon within a lower draw zone along the draw path. The lower draw roll apparatus is located between a setting zone and a separation location where the glass ribbon is separated to form a glass sheet.

This application claims the benefit of priority under 35 U.S.C. § 119 of U.S. Provisional Application Ser. No. 62/352770, filed on Jun. 21, 2016, the content of which is relied upon and incorporated herein by reference in its entirety.

### TECHNICAL FIELD

The present disclosure relates to glass manufacturing and, in particular, to a glass manufacturing apparatus and methods for manufacturing glass sheets having improved tension control.

### BACKGROUND

Standard fusion forming processes with multi-elevation drive systems offer lateral and vertical mechanical tension control within the setting zones inside of the fusion draw section, as well as isolation of setting zones from perturbation coming from glass sheet snap off by a hot end robot in bottom of draw (BOD). Since the BOD end of the ribbon is free hanging in many of these standard fusion forming processes, meaning no constraint at the downstream end of the ribbon, the ribbon below the lowest roll in the draw section is always under tension due to weight of the glass ribbon.

For ultra-thin glass, impact of perturbations can be more prominent because the weight of the portion of the glass ribbon in the BOD is relatively light, thereby providing relatively low mechanical tension. Thus, there is still a desire to enhance the glass manufacturing apparatuses and methods to have a configuration that is beneficial for a wide- range of process applications.

### SUMMARY

The present concept involves glass manufacturing apparatuses and methods of forming ultra thin glass substrates via controlling ribbon tension, using driven rolls implemented in multiple elevations, such as two or three sets of driven rolls in a draw zone of the glass manufacturing apparatuses and another set of driven rolls downstream in a bottom of the draw. The driven rolls in the draw section can control setting zone tension. Additional driven rolls at the bottom of the draw can be implemented to improve current glass forming apparatuses and methods. This tension control scheme can enable vertical tension control from root to an end of a tension control zone well downstream of the setting zone.

According to a first aspect, a glass manufacturing apparatus includes a forming device that is configured to produce a glass ribbon that includes a width extending between a first edge and an opposite second edge of the glass ribbon. A lower draw roll apparatus includes a first pair of draw rolls arranged and configured to draw the first edge of the glass ribbon within a lower draw zone along the draw path. The lower draw roll apparatus is located between a setting zone and a separation location where the glass ribbon is separated to form a glass sheet.

According to a second aspect, there is provided the apparatus of aspect 1, further comprising a control device configured to operate the lower draw roll apparatus such that the first pair of draw rolls of the lower draw roll apparatus provides a downward pull force to the glass ribbon.

According to a third aspect, there is provided the apparatus of aspect 1 or aspect 2, further comprising a first pull roll apparatus comprising a first pair of draw rolls arranged and configured to draw the first edge of the glass ribbon from the forming device within an upper draw zone that includes the setting zone along a draw path extending transverse to the width of the glass ribbon. A second pull roll apparatus downstream of the first pull roll apparatus comprises a first pair of draw rolls arranged and configured to draw the first edge of the glass ribbon within the upper draw zone along the draw path.

According to a fourth aspect, there is provided the method of aspect 3, wherein the first pull roll apparatus, the second pull roll apparatus and the lower draw roll apparatus are arranged at an angle to horizontal to apply a lateral tension to the glass ribbon.

According to a fifth aspect, there is provided the method of aspect 3, wherein the control device is configured to operate the first pairs of draw rolls of the first pull roll apparatus and the second pull roll apparatus at a substantially constant torque.

According to a sixth aspect, there is provided the method of any one of aspects 3-5, wherein the first pull roll apparatus, the second pull roll apparatus and the lower draw roll apparatus each include a second pair of draw rolls arranged and configured to draw the second edge of the glass ribbon.

According to a seventh aspect, there is provided the method of any one of aspects 3-6, wherein the control device is configured to operate the first pair of draw rolls of the lower draw roll apparatus at a substantially constant angular velocity.

According to an eighth aspect, a method of manufacturing a glass ribbon is provided. The method includes operating a lower draw roll apparatus of a pull roll device. The pull roll device is located in a lower draw zone of the glass manufacturing apparatus downstream from a setting zone. The pull roll device includes a lower draw roll apparatus including a first pair of draw rolls arranged and configured to interact with a first edge of the glass ribbon and a second pair of draw rolls arranged and configured to interact with a second edge of the glass ribbon. The draw roll apparatus of the pull roll device is controlled using a control device such that the first pair of draw rolls of the lower draw roll apparatus of the pull roll device provides a downward pull force to the glass ribbon between a separation location where the glass ribbon is separated to form a glass sheet and the setting zone.

According to a ninth aspect, there is provided the method of aspect 8, wherein the glass manufacturing apparatus further comprises a first pull roll device located in an upper draw zone of the glass manufacturing apparatus that includes the setting zone.

According to a tenth aspect, there is provided the method of aspect 9, wherein the first pull roll device includes a first pull roll apparatus that includes a first pair of draw rolls arranged and configured to draw the first edge of the glass ribbon from the forming device along a draw path extending transverse to the width of the glass ribbon. A second pull roll apparatus that is downstream of the first pull roll apparatus of the first pull roll device including a first pair of draw rolls arranged and configured to draw the first edge of the glass ribbon along the draw path.

According to an eleventh aspect, there is provided the method of aspect 10, comprising controlling the first pull roll apparatus of the first pull roll device using the control device such that the first pair of draw rolls of the first pull apparatus of the first pull roll device rotate at a substantially constant torque.

According to a twelfth aspect, there is provided the method of aspect 10 or aspect 11, comprising controlling the second pull roll apparatus of the first pull roll device using the control device such that the first pair of draw rolls of the second pull apparatus of the first pull roll device rotate at a substantially constant torque.

According to a thirteenth aspect, there is provided the method of any one of aspects 10-12, wherein the first pull roll apparatus, the second pull roll apparatus and the lower draw roll apparatus are arranged at an angle relative to horizontal to apply a lateral tension to the glass ribbon.

According to a fourteenth aspect, there is provided the method of any one of aspects 9-13, comprising controlling the lower draw roll apparatus of the pull roll device using the control device such that the first pair of draw rolls of the lower draw roll apparatus rotate at a substantially constant angular velocity.

According to a fifteenth aspect, a method of manufacturing a glass ribbon is provided. The method includes operating a first pull roll device located in an upper draw zone of the glass manufacturing apparatus. The first pull roll device draws a glass ribbon from a forming device. A second pull roll device located in a lower draw zone of the glass manufacturing apparatus downstream from the first pull roll device is operated. The second pull roll device isolates tension of the glass ribbon in the upper draw zone from a separation location where the glass ribbon is separated to form a glass sheet.

According to a sixteenth aspect, there is provided the method of aspect 15, wherein the first pull roll device includes a first pull roll apparatus including a first pair of draw rolls arranged and configured to draw the first edge of the glass ribbon from the forming device along a draw path extending transverse to the width of the glass ribbon. A second pull roll apparatus downstream of the first pull roll apparatus of the first pull roll device includes a first pair of draw rolls arranged and configured to draw the first edge of the glass ribbon along the draw path.

According to a seventeenth aspect, there is provided the method of aspect 16, comprising controlling the first pull roll apparatus of the first pull roll device using a control device such that the first pair of draw rolls of the first pull apparatus of the first pull roll device rotate at a substantially constant torque.

According to an eighteenth aspect, there is provided the method of any one of aspects 15-17, comprising controlling the second pull roll apparatus of the first pull roll device using a control device such that the first pair of draw rolls of the second pull apparatus of the first pull roll device rotate at a substantially constant torque.

According to a nineteenth aspect, there is provided the method of any one of aspects 16-18, wherein the first pair of draw rolls of at least one of the first pull roll apparatus and the second pull roll apparatus of the first pull roll device are arranged at an angle relative to horizontal to apply a lateral tension to the glass ribbon.

According to a twentieth aspect, there is provided the method of aspect any one of aspects 15-19, wherein the second pull roll device comprises a lower draw roll apparatus comprising a first pair of draw rolls arranged and configured to interact with the first edge of the glass ribbon.

According to a twenty-first aspect, there is provided the apparatus of aspect 20 comprising controlling the lower draw roll apparatus of the second pull roll device using a control device such that the first pair of draw rolls of the lower draw roll apparatus provides a downward pull force to the glass ribbon.

According to a twenty-second aspect, there is provided the apparatus of aspect 21, wherein the first pair of draw rolls of the lower draw roll apparatus are controlled by the control device to rotate at a substantially constant angular velocity.

Additional features and advantages will be set forth in the detailed description which follows, and in part will be readily apparent to those skilled in the art from the description or recognized by practicing the invention as exemplified in the written description and the appended drawings and as defined in the appended claims. It is to be understood that both the foregoing general description and the following detailed description are merely exemplary of the invention, and are intended to provide an overview or framework to understanding the nature and character of the invention as it is claimed.

The accompanying drawings are included to provide a further understanding of principles of the invention, and are incorporated in and constitute a part of this specification. The drawings illustrate one or more embodiment(s), and together with the description serve to explain, by way of example, principles and operation of the invention. It is to be understood that various features of the invention disclosed in this specification and in the drawings can be used in any and all combinations.

### BRIEF DESCRIPTION OF THE DRAWINGS

FIG. 1 is a schematic view of an embodiment of a flexible glass forming method and apparatus;

FIG. 2 is an isometric view of portions of the glass manufacturing apparatus of FIG. 1 including an embodiment of a pull roll device;

FIG. 3 is an isometric view of portions of the glass manufacturing apparatus of FIG. 1 including another embodiment of a pull roll device;

FIG. 4 illustrates both front and side views of the glass manufacturing apparatus of the portions of FIGS. 2 and 3; and

FIG. 5 is an exemplary tension diagram for an exemplary glass forming process where tension along the glass ribbon is plotted over distance.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Embodiments described herein generally relate to glass manufacturing apparatuses and methods for manufacturing a glass ribbon having improved tension control by operating driven rollers that are controlled to have constant velocity at a bottom of the draw (BOD) or lower draw region of the glass ribbon, nearer a snap off location by a hot end robot. Such an arrangement can allow for vertical tension control of the glass ribbon from the root through the lower draw driven rollers. In addition, the downward pull force of the lower draw driven rollers can add vertical mechanical tension upstream of the lower draw driven rollers and hence lower pulling machine area, which can reduce motion of the glass ribbon in that lower pulling machine area downstream of the lower draw driven rollers. Furthermore, having the lower draw driven rollers relatively far downstream of the setting zone can reduce motion of the glass ribbon within the setting zone, which can improve attributes of the glass ribbon, such as shape and glass stress.

While glass is generally known as a brittle material, inflexible and prone to scratching, chipping and fracture, glass having a thin cross section can in fact be quite flexible. Glass in long thin sheets or ribbons can be wound and un-wound from rolls, much like paper or plastic film. Instabilities, perturbations, vibrations, and transient effects that may exist in manufacturing environments or in processing and handling equipment may cause intermittent or extended misalignment of the glass ribbon to occur. In extreme cases, the instabilities, perturbations, vibrations, and transient effects of the glass ribbon may lead to fracture. Thus, it can be beneficial to provide isolation between various zones to inhibit transmission of instabilities, perturbations, vibrations and transient effects from the source, along the glass ribbon, up and down the glass ribbon to other processes.

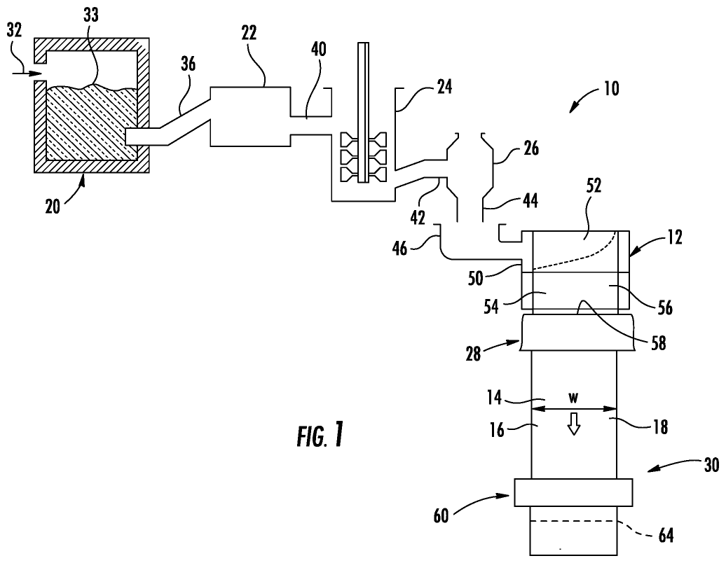

Referring to FIG. 1, a schematic view of an embodiment of an exemplary glass manufacturing apparatus 10 is illustrated as a down draw fusion apparatus, although other glass forming apparatuses may be used in other examples. The exemplary glass manufacturing apparatus 10 may include a forming device 12 to produce a glass ribbon 14 including a width W extending between a first edge 16 and a second edge 18.

The glass manufacturing apparatus 10 can include a melting vessel 20, a fining vessel 22, a mixing vessel 24, a delivery vessel 26, the forming device 12 and pull roll devices (represented by elements 28 and 30). The melting vessel 20 may be where glass batch materials are introduced as shown by arrow 32 and melted to form molten glass 33. The fining vessel 22 has a high temperature processing area that receives the molten glass 33 from the melting vessel 20 through an inclined tube 36 and in which bubbles are removed from the molten glass 33. The fining vessel 22 is connected to the mixing vessel 24 by a finer to stir chamber connecting tube 40. The mixing vessel 24 is connected to the delivery vessel 26 by a stir chamber to bowl connecting tube 42. The delivery vessel 26 delivers the molten glass 33 through a downcomer 44 to an inlet 46 and into the forming device 12.

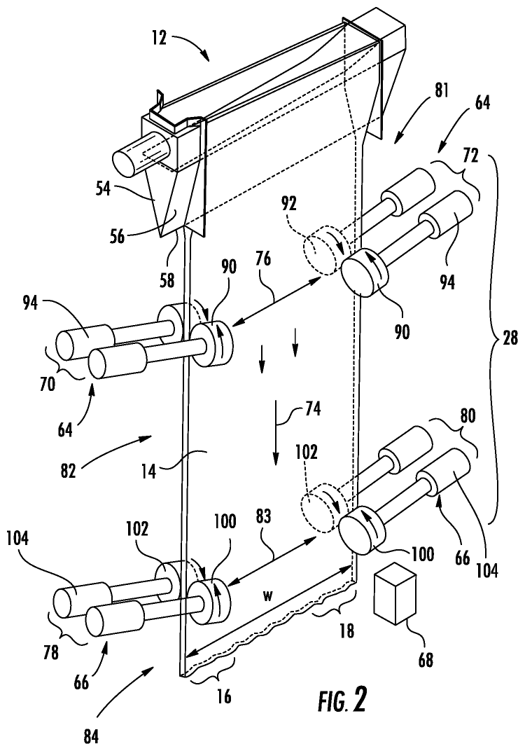

There may be various forming devices which may be used in accordance with aspects of the disclosure. For example, as shown in FIGS. 1 and 2, the exemplary forming device 12 includes an opening 50 that receives the molten glass 33 which flows into a trough 52. As best shown in FIG. 2, the molten glass 33 then overflows from the trough 52 and runs down two sides 54 and 56 before fusing together at a root 58 of the forming device 12. The root 58 is where the two sides 54 and 56 come together and where the two overflow walls of molten glass 33 flowing over each of the two sides 54 and 56 fuse together to form the glass ribbon 14 which is drawn downward off the root 58.

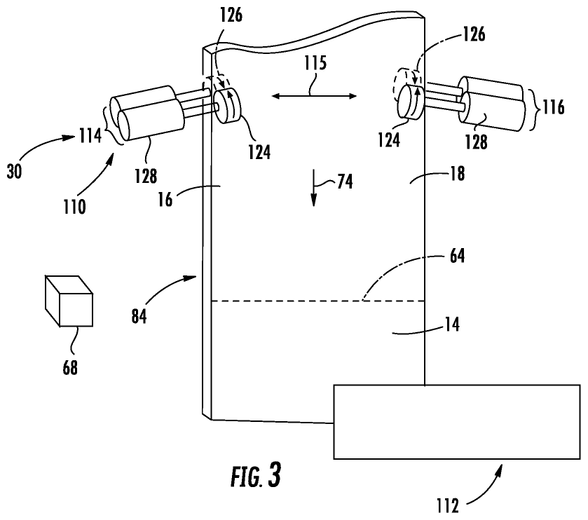

The glass manufacturing apparatus 10 may further include the pull roll devices 28 and 30 which are both schematically illustrated in FIG. 1. As will be discussed more fully below with respect to FIGS. 2 and 3, the pull roll device 28 is provided to help draw the glass ribbon 14 from the root 58 and also draw the glass ribbon 14 to the desired thickness. The pull roll device 30 is provided to maintain vertical and horizontal ribbon tension within a lower draw zone 60 downstream of a setting zone 82 (FIG. 2) and upstream of a ribbon separation location 64 where a hot end robot (sometimes referred to as a travelling anvil machine or TAM) separates the glass ribbon 14.

In embodiments where the glass ribbon 14 is formed using a down draw fusion process, the first and second edges 16 and 18 may include beads with a thickness that is greater than a thickness within a central portion. The central portion may be “ultra-thin” having a thickness of about 0.3 mm or less including but not limited to thicknesses of, for example, about 0.01-0.05 mm, about 0.05-0.1 mm, about 0.1-0.15 mm and about 0.15-0.3 mm, although glass ribbons 34 with other thicknesses may be formed in other examples.

Referring to FIG. 2, a more detailed schematic is provided of the pull roll device 28 in accordance with one example of the disclosure. The exemplary pull roll device 28 can include a first roll apparatus 64, a second roll apparatus 66 and a control device 68 (e.g., programmable logic controller, processor-memory etc.). In some embodiments, the roll device 28 may include a third or more roll apparatuses, such as an idle roll apparatus between the first roll apparatus 64 and the second roll apparatus 66. In this example, the first roll apparatus 64 may include a first pair of draw rolls 70 and a second pair of draw rolls 72 configured to respectively draw the first edge 16 and the second edge 18 of the glass ribbon 14 from the forming device 12 along a draw path 74 extending transverse to the width W of the glass ribbon 14 (note: the draw rolls 70 and 72 are shown as being vertically down-tilted rolls and applying a cross-tension 76 in the glass ribbon 14 but they could have a horizontal orientation and if they have a horizontal orientation then they could be connected to one another).

The second roll apparatus 66 includes a first pair of rolls 78 and a second pair of rolls 80 which are respectively positioned downstream along the draw path 74 from the first pair of draw rolls 70 and the second pair of draw rolls 72 (note: the rolls 78 and 80 are shown as being vertically down-tilted rolls and applying a cross-tension 83 in the glass ribbon 14 but they could have a horizontal orientation and if they have a horizontal orientation then they could be connected to one another). The control device 68 is configured at least to independently operate the first roll apparatus 64 and the second roll apparatus 66 such that at both of the pairs of draw rolls 70, 72 and 78, 80 rotate with a substantially constant torque.

There are various schematics of the forming device 12 and the pull roll device 28 in accordance with several examples of the disclosure. The pull roll device may 28 operate to draw the glass ribbon 14 from the root 58 of the forming device 12 into a viscous zone 81 wherein the glass ribbon 14 begins thinning to a final thickness. The glass ribbon 14 may then be drawn from the viscous zone 81 into a setting zone 82. In the setting zone 82, the portion of the glass ribbon 14 is set from a viscous state to an elastic state with the desired profile. The setting zone 82 can be defined as the zone where the temperatures satisfy the following

$$0.2 sec < \frac{η ( T )}{G} < 1000 sec ,$$

with η being the glass viscosity (Pa sec), T being the temperature (° C.) and G being the room temperature shear modulus (Pa) of the glass ribbon 14. The glass ribbon 14 can then be drawn from the setting zone 82 to an elastic zone 84. Once in the elastic zone 84, the glass ribbon 14 may be deformed, within limits, without permanently changing the profile of the glass ribbon 14. In this example, the pull roll device 28 is configured such that the first pair of draw rolls 70 and the second pair of draw rolls 72 are located in the viscous zone 81 and the first pair of draw rolls 78 and the second pair of draw rolls 80 are located in the setting and/or elastic zone 82, 84.

Each of the first and second pair of draw rolls 70, 72 can include a first pull roll member 90 and a second pull roll member 92. The first and second pull roll members 90 and 92 can each be provided with a refractory roll covering, and respective pairs of them (i.e., first pair of draw rolls 70 and second pair of draw rolls 72) are arranged to engage the first and second edges 16 and 18 of the glass ribbon 14 therebetween. At least one of the first and second pull roll members 90 and 92 in each pair of draw rolls 70, 72 may be provided with a respective motor 94. For example, as shown, the first pull roll member 90 of the second pair of draw rolls 72 is provided with a motor 94 whereas the second pull roll member 92 of the second pair of draw rolls 72 is provided with a bearing such that only one of the first and second pull roll members 90 or 92 is driven and the other rolls from contact with glass ribbon and pinch force with the other roller. Similarly, the second pull roll member 92 of the first pair of draw rolls 70 is provided with a motor 94, whereas the first pull roll member 90 of the first pair of draw rolls 70 is provided with a bearing such that only one of the first and second pull roll members 90 or 92 is driven and the other rolls from contact with the glass ribbon and pinch force with the other roll. In further examples, both of the first and second pull roll members 90 or 92 in one pair of draw rolls (for example either the first pair of draw rolls 70, the second pair of draw rolls 72, or both pairs of draw rolls 70, 72) may be provided with a motor.

The pull roll device 28 may further include the apparatus 66 including the first and second pair of draw rolls 78 and 80 positioned downstream along the draw path 74 from the pair of rolls 70, 72. The first and second pair of draw rolls 78 and 80 may be configured to further draw the first and second edges 16 and 18 of the glass ribbon 14 along the draw path 74. As shown, each of the first and second pair of draw rolls 78 and 80 can include a first pull roll member 100 and a second pull roll member 102. The first and second pull roll members 100 and 102 can each be provided with a respective refractory roll covering and respective pairs of them (i.e., first pair of draw rolls 78 and second pair of draw rolls 80) are arranged to engage the first and second edges 16 and 18 of the glass ribbon 14 therebetween. At least one of the first and second pull roll members 100 and 102 in each pair of draw rolls 78, 80 may be provided with a respective motor 104. For example, as shown, the first pull roll member 100 of the second pair of draw rolls 80 is provided with a motor 104, whereas the second pull roll member 102 of the second pair of draw rolls 80 is provided with a bearing such that only one of the first and second pull roll members 100 or 102 is driven and the other rolls from contact with the glass ribbon and pinch force with the other roll. In further examples, both of the first and second pull roll members 100 or 102 in one pair of draw rolls (for example either the first pair of draw rolls 78, the second pair of draw rolls 80, or both pairs of draw rolls 78, 80) may be provided with a motor.

Referring to FIG. 3, a more detailed schematic of the pull roll device 30 in accordance with the present disclosure is illustrated. The exemplary pull roll device 30 includes a lower draw roll apparatus 110. The lower draw roll apparatus is located in the BOD, near the separation location 64 where the TAM 112 cuts the drawn glass ribbon 14 into distinct pieces of glass sheets. At this separation location 64, the glass sheet 14 is hot, significantly above room temperature. This area may be referred to as the Hot BOD (HBOD) as the glass sheet 14 is still hot. In this embodiment, the lower draw roll apparatus 110 may include a first pair of draw rolls 114 and a second pair of draw rolls 116 configured to respectively draw the first edge 16 and the second edge 18 of the glass ribbon 14 from the elastic zone 84 along the draw path 74 (note: the draw rolls are shown as being vertically down-tilted rolls and applying a cross-tension 115 in the glass ribbon 14 but they could have a horizontal orientation and if they have a horizontal orientation then they could be connected to one another).

Each of the first and second pair of draw rolls 114, 116 can include a first pull roll member 124 and a second pull roll member 126. The first and second pull roll members 124 and 126 can each be provided with a respective refractory roll covering and respective pairs of them (i.e., first pair of draw rolls 114 and second pair of draw rolls 116) are arranged to engage the first and second edges 16 and 18 of the glass ribbon 14 therebetween. At least one of the first and second pull roll members 124 and 126 in each pair of draw rolls 114, 116 may be provided with a respective motor 128. For example, as shown, the first roll member 124 of the second pair of draw rolls 116 is provided with a motor 128, whereas the second pull roll member 126 of the second pair of draw rolls 116 is provided with a bearing such that only one of the first and second pull roll members 124 or 126 is driven and the other rolls from contact with the glass ribbon and pinch force with the other roll.

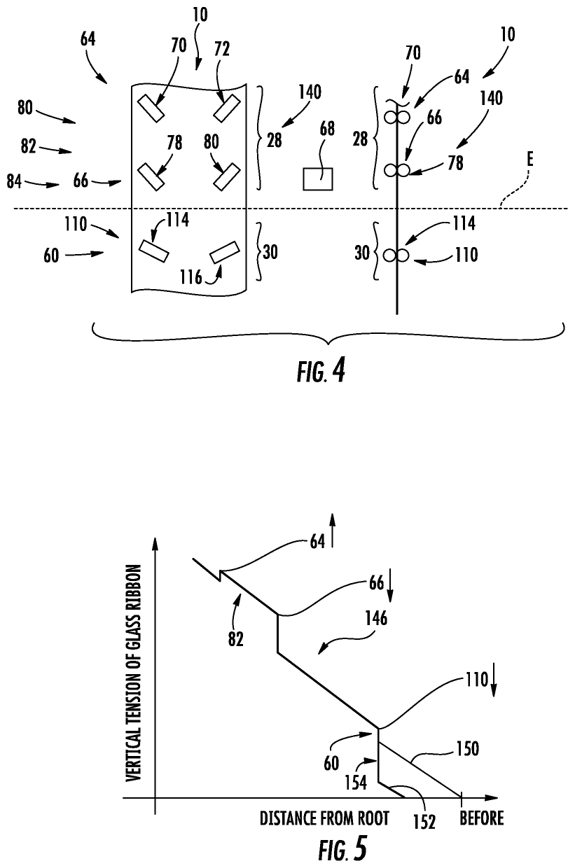

Referring now to FIG. 4, both front and side views of the glass manufacturing apparatus 10 are schematically illustrated including the viscous, setting and elastic zones 80, 82 and 84, which may be collectively referred to as an upper draw zone 140 where the pull roll device 28 is located and the lower draw zone 60 where the pull roll device 30 is located. An imaginary line E symbolizes an exit from the upper draw zone 140 to the lower draw zone 60.

The control device 68 may be provided to independently operate one or more of the first and second roll apparatuses 64 and 66 of the pull roll device 28 and the lower draw roll apparatus 110 of the pull roll device 30. As one example, the control device 68 may operate the first and second pair of draw rolls 70 and 72 of the first roll apparatus 64 to rotate with a substantially constant torque and the first and second pair of draw rolls 78 and 80 of the second roll apparatus 66 with also a substantially constant torque. The draw rolls 114 and 116 of the lower draw roll apparatus 110 may be operated at a substantially constant velocity. Independent operation of the first and second roll apparatuses 64 and 66 of the pull roll device 28 and the lower draw roll apparatus 110 of the pull roll device 30 means that the roll apparatuses 64, 66, 110 may be operated without being affected by operation of one or more of the others of the roll apparatuses 64, 66, 110.

Referring to FIG. 5, a tension diagram 146 is illustrated for an exemplary glass forming process using the glass manufacturing apparatus 10 where tension along the glass ribbon 14 is plotted over distance from the root 58 (FIG. 1). FIG. 5 corresponds to the configuration above with upward torque for roll apparatuses 64 and downward torque for roll apparatus 66. The lower draw roll apparatus 110 is provided with substantially constant velocity. The vertical arrows of FIG. 5 indicate the direction of the torque applied. In this particular example, the torque control driven roll apparatus 64 applies an upward pull force to apply a desired tension to zone 82. As used herein, the term “upward pull force” refers to a force providing a tensile force downstream of the particular roll apparatus, while a “downward pull force” refers to a force providing a compressive force downstream of the particular roll apparatus. The torque control driven roll apparatus 66 controls thickness of the glass ribbon. The lower draw roll apparatus 110 is driven and controlled by velocity to decrease tension in the lower draw zone 60 to isolate zone 82 from downstream perturbations. A tension variation 154 is provided between lines 150 and 152 due to removal of a length of glass sheet from the glass ribbon 14 at the TAM 112.

It should be emphasized that the above-described embodiments of the present disclosure, particularly any “preferred” embodiments, are merely possible examples of implementations, merely set forth for a clear understanding of various principles of the disclosure. Many variations and modifications may be made to the above-described embodiments of the disclosure without departing substantially from the spirit and various principles of the disclosure. All such modifications and variations are intended to be included herein within the scope of this disclosure and the following claims.

1. A glass manufacturing apparatus comprising:
a forming device configured to produce a glass ribbon including a width extending between a first edge and an opposite second edge of the glass ribbon; and
a lower draw roll apparatus comprising a first pair of draw rolls arranged and configured to draw the first edge of the glass ribbon within a lower draw zone along the draw path, the lower draw roll apparatus located between a setting zone and a separation location where the glass ribbon is separated to form a glass sheet.

2. The glass manufacturing apparatus of claim 1 further comprising a control device configured to operate the lower draw roll apparatus such that the first pair of draw rolls of the lower draw roll apparatus provides a downward pull force to the glass ribbon.

3. The glass manufacturing apparatus of claim 2 further comprising:
a first pull roll apparatus comprising a first pair of draw rolls arranged and configured to draw the first edge of the glass ribbon from the forming device within an upper draw zone that includes the setting zone along a draw path extending transverse to the width of the glass ribbon; and
a second pull roll apparatus downstream of the first pull roll apparatus comprising a first pair of draw rolls arranged and configured to draw the first edge of the glass ribbon within the upper draw zone along the draw path.

4. The glass manufacturing apparatus of claim 3, wherein the first pull roll apparatus, the second pull roll apparatus and the lower draw roll apparatus are arranged at an angle to horizontal to apply a lateral tension to the glass ribbon.

5. The glass manufacturing apparatus of claim 3, wherein the control device is configured to operate the first pairs of draw rolls of the first pull roll apparatus and the second pull roll apparatus at a substantially constant torque.

6. The glass manufacturing apparatus of claim 3, wherein the first pull roll apparatus, the second pull roll apparatus and the lower draw roll apparatus each include a second pair of draw rolls arranged and configured to draw the second edge of the glass ribbon.

7. The glass manufacturing apparatus of claim 3, wherein the control device is configured to operate the first pair of draw rolls of the lower draw roll apparatus at a substantially constant angular velocity.

8. A method of manufacturing a glass ribbon comprising:
operating a lower draw roll apparatus of a pull roll device, the pull roll device located in a lower draw zone of the glass manufacturing apparatus downstream from a setting zone, the pull roll device comprising:
a lower draw roll apparatus comprising a first pair of draw rolls arranged and configured to interact with a first edge of the glass ribbon and a second pair of draw rolls arranged and configured to interact with a second edge of the glass ribbon, wherein the draw roll apparatus of the pull roll device is controlled using a control device such that the first pair of draw rolls of the lower draw roll apparatus of the pull roll device provides a downward pull force to the glass ribbon between a separation location where the glass ribbon is separated to form a glass sheet and the setting zone.

9. The method of claim 8, wherein the glass manufacturing apparatus further comprises a first pull roll device located in an upper draw zone of the glass manufacturing apparatus that includes the setting zone.

10. The method of claim 9, wherein the first pull roll device comprises:
a first pull roll apparatus comprising a first pair of draw rolls arranged and configured to draw the first edge of the glass ribbon from the forming device along a draw path extending transverse to the width of the glass ribbon; and
a second pull roll apparatus downstream of the first pull roll apparatus of the first pull roll device comprising a first pair of draw rolls arranged and configured to draw the first edge of the glass ribbon along the draw path.

11. The method of claim 10 comprising controlling the first pull roll apparatus of the first pull roll device using the control device such that the first pair of draw rolls of the first pull apparatus of the first pull roll device rotate at a substantially constant torque.

12. The method of claim 10 comprising controlling the second pull roll apparatus of the first pull roll device using the control device such that the first pair of draw rolls of the second pull apparatus of the first pull roll device rotate at a substantially constant torque.

13. The method of claim 10, wherein the first pull roll apparatus, the second pull roll apparatus and the lower draw roll apparatus are arranged at an angle relative to horizontal to apply a lateral tension to the glass ribbon.

14. The method of claim 8 comprising controlling the lower draw roll apparatus of the pull roll device using the control device such that the first pair of draw rolls of the lower draw roll apparatus rotate at a substantially constant angular velocity.

15. A method of manufacturing a glass ribbon comprising:
operating a first pull roll device located in an upper draw zone of the glass manufacturing apparatus, the first pull roll device drawing a glass ribbon from a forming device; and
operating a second pull roll device located in a lower draw zone of the glass manufacturing apparatus downstream from the first pull roll device, the second pull roll device isolating tension of the glass ribbon in the upper draw zone from a separation location where the glass ribbon is separated to form a glass sheet.

16. The method of claim 15, wherein the first pull roll device comprises:
apparatus comprising a first pair of draw rolls arranged and configured to draw the first edge of the glass ribbon from the forming device along a draw path extending transverse to the width of the glass ribbon; and
a second pull roll apparatus downstream of the first pull roll apparatus of the first pull roll device comprising a first pair of draw rolls arranged and configured to draw the first edge of the glass ribbon along the draw path.

17. The method of claim 16 comprising controlling the first pull roll apparatus of the first pull roll device using a control device such that the first pair of draw rolls of the first pull apparatus of the first pull roll device rotate at a substantially constant torque.

18. The method of claim 16 comprising controlling the second pull roll apparatus of the first pull roll device using a control device such that the first pair of draw rolls of the second pull apparatus of the first pull roll device rotate at a substantially constant torque.

19. The method of claim 16, wherein the first pair of draw rolls of at least one of the first pull roll apparatus and the second pull roll apparatus of the first pull roll device are arranged at an angle relative to horizontal to apply a lateral tension to the glass ribbon.

20. The method of claim 15, wherein the second pull roll device comprises a lower draw roll apparatus comprising a first pair of draw rolls arranged and configured to interact with the first edge of the glass ribbon.

21. The method of claim 20 comprising controlling the lower draw roll apparatus of the second pull roll device using a control device such that the first pair of draw rolls of the lower draw roll apparatus provides a downward pull force to the glass ribbon.

22. The method of claim 20, wherein the first pair of draw rolls of the lower draw roll apparatus are controlled by the control device to rotate at a substantially constant angular velocity.
